(19) United States
(12) Patent Application Publication
(10) Pub. No.: US 2003/0105209 A1
(43) Pub. Date: Jun. 5, 2003

(54) Flame retardant polycarbonate composition

(76) Inventors: James Y.J. Chung, Wexford, PA (US); Winfried G. Paul, Coraopolis, PA (US)

Correspondence Address: BAYER POLYMERS LLC, 100 BAYER ROAD, PITTSBURGH, PA, 15205, US

(21) Appl. No.: 09/990,128

(22) Filed: Nov. 21, 2001

(51) Int. Cl. C08K 3/34; C08K 11/00

(52) U.S. Cl. 524/451; 524/442

(57) ABSTRACT

A flame retardant thermoplastic molding composition is disclosed. The composition contains polycarbonate resin and about 0.1-1.5 percent by weight of hydrotalcite.

### FIELD OF THE INVENTION

The invention concerns thermoplastic molding compositions and more particularly, flame-retardant polycarbonate compositions.

### SUMMARY OF THE INVENTION

A flame-retardant thermoplastic molding composition is disclosed. The composition contains polycarbonate resin and about 0.1-1.5 percent by weight of hydrotalcite.

### BACKGROUND OF THE INVENTION

Polycarbonate resins are well known and have long been used for a variety of applications because of their characteristic combination of good mechanical and physical properties. Flame retardant thermoplastic molding compositions containing polycarbonate resins are likewise known yet the flame retardance is often attained at the sacrifice of other properties. The search has been continuing for polycarbonate compositions that exhibit goof flame retardance with minimal loss of other properties. Hydrotalcite is a known natural mineral, which is produced, in relatively small amounts in limited areas. It is also known to produce synthetic hydrotalcites by the reaction of a carbonate source, a magnesium source, and an aluminum source. U.S. Pat. Nos. 3,539,306; 3,650,704 and 4,351,814 disclose the preparation of synthetic hydrotalcites. U.S. Pat. No. 6,291,570 disclosed a flame retardant resin composition that contains hydrotalcite compound particles. Accordingly disclosed was a substantially halogen-free flame retardant synthetic resin composition that contains a synthetic resin and hydrotalcite compound particles in an amount of more than 10 wt % and 80 wt % or less based on the total weight of the components. U.S. Pat. No. 4,729,854 disclosed a fire-retardant composition that contains a thermoplastic or a thermosetting resin, a halogen-containing organic fire retardant, and an additive amount of a hydrotalcite defined in terms of its specific surface area, said to be a stabilizer. U.S. Pat. No. 4,154,718 disclosed A fire-retardant thermoplastic resin composition consisting essentially of: (A) a thermoplastic synthetic resin, (B) about 40 to 150 parts by weight of the thermoplastic synthetic resin of a magnesium-containing inorganic compound selected from the group consisting of magnesium hydroxide, basic magnesium carbonate hydrate and hydrotalcites, and (C) a fire-retardant assistant selected from a specified group of specified compounds.

### DETAILED DESCRIPTION OF THE INVENTION

The hydrotalcite suitable in the context of the present invention is an inorganic metal complex. This mineral, including synthetic minerals has a layered structure of Aluminum and Magnesium. A typical hydrotalcite may be represented by the formula Mg₄Al₂(OH)₁₂CO₃3H₂O. Other suitable hydrotalcite minerals refer to modifications of this formula made by changing the Al to Mg ratio and by including other metal compounds such as zinc oxide. Preferably the Mg is not substituted.

The preferred hydrotalcite is represented as Mg₄₋₅Al₂ (OH)₁₃ CO₃. It is commercially available as Kyowa DHT-4C from Mitsui USA.

The amount of hydrotalcite in the inventive composition is 0.1 to 1.5, preferably 0.1 to 1.2 percent relative to the weight of the composition. In a preferred embodiment of the invention the composition contains no additional flame retarding agents such as phosphorous compounds and/or halogenated compounds that are known for their flame retardant utility in polycarbonate compositions.

The preferred hydrotalcite has an average particle diameter of 2 microns, preferably 0.4 to 1.0 microns. Further, the hydrotalcite is preferably characterized in that its specific surface area, measured by the BET method is 1 to 30, more preferably 3 to 20, most preferably 3 to 12 m²/g.

The method and conditions for producing the hydrotalcite of the present invention are known see for instance U.S. Pat. Nos. 3,650,704 and 3,879,525 incorporated by reference herein.

Suitable polycarbonate resins for preparing the copolymer of the present invention are homopolycarbonates and copolycarbonates and mixtures thereof.

The polycarbonates generally have a weight average molecular weight of 10,000 to 200,000, preferably 20,000 to 80,000 and their melt flow rate, per ASTM D-1238 at 300° C., is about 1 to about 65 g/10 min., preferably about 2 to 24 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formulae (1) or (2).

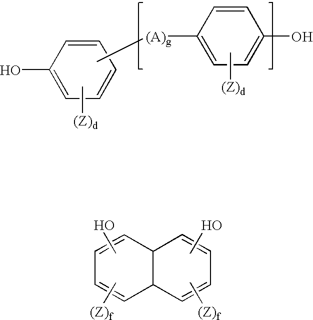

wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

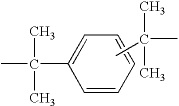

e and g both denote the number 0 to 1;

Z denotes F, Cl, Br or C₁-C₄-alkyl and if several Z radicals are substituents in one aryl radical, they may be identical or different from one another;

d denotes an integer from 0 to 4; and

f denotes an integer from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxyphenyl)-sulfoxides, bis-(hydroxyphenyl)-sulfides, bis-(hydroxyphenyl)-sulfones, dihydroxydiphenyl cycloalkanes, and α,α-bis-(hydroxyphenyl)-diisopropyl-benzenes, as well as their nuclear-alkylated compounds. These and further suitable aromatic dihydroxy compounds are described, for example, in U.S. Pat. Nos. 5,227,458, 5,105,004; 5,126,428; 5,109,076; 5,104,723; 5,086,157; 3,028,356; 2,999,835; 3,148,172; 2,991,273; 3,271,367; and 2,999,846, all incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropylbenzene and 4,4′-sulfonyl diphenol.

Examples of particularly preferred aromatic bisphenols are 2,2,-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention is phenolphthalein-based polycarbonate, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05 to 2.0 mol % (relative to the bisphenols) of polyhydroxy compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxy compounds which may be used for this purpose: phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference, U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention such as disclosed in U.S. Pat. No. 3,912,688, incorporated herein by reference, may be used.

Suitable polycarbonate resins are available in commerce, for instance, Makrolon FCR, Makrolon 2600, Makrolon 2800 and Makrolon 3100, all of which are bisphenol based homopolycarbonate resins differing in terms of their respective molecular weights and characterized in that their melt flow indices (MFR) per ASTM D-1238 are about 16.5 to 24, 13 to 16, 7.5 to 13.0 and 3.5 to 6.5 g/10 min., respectively. These are products of Bayer Corporation of Pittsburgh, Pa.

A polycarbonate resin suitable in the practice of the invention is known and its structure and methods of preparation have been disclosed, for example, in U.S. Pat. Nos. 3,030,331; 3,169,121; 3,395,119; 3,729,447; 4,255,556; 4,260,731; 4,369,303 and 4,714,746 all of which are incorporated by reference herein.

### EXAMPLES

accordance with the present invention compositions containing Makrolon 2608 polycarbonate resin (a bisphenol-A based homopolycarbonate having a melt flow rate of about 11 g/10 min. per ASTM D 1238, a product of Bayer Corporation and the indicated amounts of hydrotalcite (Kyowa DHT-4C), a product of Mitsui USA were prepared and their properties evaluated as shown in the table below.

The results show that melt processable polycarbonate compositions that feature a flame retardance need to contain no more than 1.5%, the percent being relative to the weight of the composition of hydrotalcite. The incorporation of higher amounts of hydrotalcite tended to degrade the polycarbonate very significantly. For example, a formulation containing 3% DHT-4C was thermo-hydrolytically so unstable that its melt flow rate was too high to measure, while passing UL94-V2 at ⅛″. This degradation is much more significant for an old DHT sample (stored in room temperature for about 10 months after opening its originally sealed bag) than for new (fresh from the sealed bag) DHT samples due to moisture absorption during storage. The present inventive composition entails 0.1% to 1.5% of hydrotalcite for flame retardant PC compositions to attain flame retardance rating of UL 94-V2 or UL94-V0 at ⅛″. The examples that incorporated hydrotalcite that appear to have absorbed moisture during storage resulted in some degradation of the polycarbonate during processing.

| Example | 1 | 2 | 3 | 4 | 5 | 6 | 7 | 8 | 9 | 10⁽¹⁾ |
|---|---|---|---|---|---|---|---|---|---|---|
| Polycarbonate | 99.5 | 99.9 | 99.8 | 99.7 | 99.4 | 98.6 | 99.9 | 99 | 97 | 95 |
| Hydrotalcite⁽⁴⁾ | 0.05 | 0.1 | 0.2 | 0.3 | 0.6 | 1.2 | 0.001 | 1 | 3 | 5 |
| MFR⁽²⁾ gm/10 min. | 12.4 | 12.2 | 11.6 | 10.6 | 9.8 | 12.2 | 11.4 | 132.7 | ⁽³⁾ | |
| MFR (Regrinds), | 14.7 | 18.6 | 38.1 | 52.1 | 98.7 | 99.6 | 12 | 151.7 | ⁽³⁾ | |
| gm/10 min. | | | | | | | | | | |
| Notched Izod Impact | 17.3 | 16.7 | 16.3 | 2.2 | 1.6 | 0.7 | 18 | 2 | 0.5 | |
| (1/8″) | | | | | | | | | | |
| UL94 (1/8″) | Fail | V2 | V2 | V2 | V2 | V0 | fail | V2 | V2 | |

⁽¹⁾impossible to extrude; no samples were prepared.
⁽²⁾MFR determined in accordance with ASTM D 1238,
⁽³⁾impossible to measure
⁽⁴⁾The hydrotalcite used in the preparation of examples 1-6 was fresh out of a sealed container; the material used in examples 7-10 was used about 10 months after opening of the bag, and appears to have absorbed water during storage

Although the invention has been described in detail in the foregoing for the purpose of illustration, it is to be understood that such detail is solely for that purpose and that variations can be made therein by tghose skilled in the art without departing from the spirit and scope of the invention except as it may be limited by the claims.

What is claimed is:

1. A thermoplastic molding composition comprising polycarbonate resin and hydrotalcite, the hydrotalcite being present in an amount of 0.1 to 1.5 percent relative to the weight of the composition.

2. The thermoplastic molding composition of claim 1 wherein the amount is 0.1 to 1.2 percent.

3. The thermoplastic molding composition of claim 1 wherein the hydrotalcite is represented by the formula Mg₄Al₂(OH)₁₂CO₃3H₂O.

4. The thermoplastic molding composition of claim 1 wherein the hydrotalcite is represented by the formula Mg₄₋₅Al₂ (OH)₁₃CO_{3.}

5. The thermoplastic molding composition of claim 1 characterized in the absence therefrom of flame retarding agents selected from the group of phosphorous compounds and halogenated compounds.

6. The thermoplastic molding composition of claim 1 wherein the hydrotalcite has an average particle diameter of 2 microns.

7. The thermoplastic molding composition of claim 1 wherein the hydrotalcite has an average particle diameter of 0.4 to 1.0 microns.
